(19) United States
(12) Patent Application Publication
(10) Pub. No.: US 2016/0054706 A1
(43) Pub. Date: Feb. 25, 2016

(54) WATCHES

(71) Applicant: Bulova Corporation, Woodside, NY (US)

(72) Inventor: Gregory Thumm, White Plains, NY (US)

(21) Appl. No.: 14/520,047

(22) Filed: Oct. 21, 2014

Related U.S. Application Data
(60) Provisional application No. 62/040,753, filed on Aug. 22, 2014.

(51) Int. Cl. G04B 37/00

(52) U.S. Cl. CPC G04B 37/0008

(57) ABSTRACT

A method of forming a watch case includes stamping 24 carat gold into a form having a Vickers hardness of about 65 to 75 and machining the form into a watch case. Machining can include drilling, milling, and the like. The result is a 24 carat gold watch case, e.g., formed by the process described above.

### CROSS-REFERENCE TO RELATED APPLICATIONS

This application claims priority to U.S. Provisional Patent Application Ser. No. 62/040,753 filed Aug. 22, 2014, which is incorporated by reference herein in its entirety.

### BACKGROUND OF THE INVENTION

1. Field of the Invention

The present disclosure relates to watches, and more particularly to gold watches.

2. Description of Related Art

A variety of gold watches are known in the art. Typically in order for a watch case to adequately protect its movement and/or maintain its shape, it must be made of a relatively hard alloy, such as 18 carat gold. Softer alloys, including 24 carat gold, are not hard enough for typical processing, such as machining, that are used to form watch cases. Moreover, softer alloys, including 24 carat gold, traditionally could not be used for watch cases because they would not adequately protect the watch movement. Any impact, such as in ordinary daily use, to the gold case would deform the case to an extent that would interfere with proper function of the movement and/or with proper water resistance. Therefore, traditional gold watches are made from 18 carat gold, or harder gold alloys.

Such conventional methods and systems have generally been considered satisfactory for their intended purpose. However, there is still a need in the art for improved gold watches. The present disclosure provides a solution for this need.

### SUMMARY OF THE INVENTION

A method of forming a watch case includes work hardening 24 carat gold into a form having a Vickers hardness of about 65 to 75. The method also includes machining the form into a watch case.

Work hardening can include stamping 24 carat gold into a form. For example, work hardening and machining can include work hardening 24 carat gold into forms for an upper case, middle case, and a lower case, wherein machining includes machining at least one of the forms. The method can further include assembling the forms together into a watch case.

It is contemplated that the method can include housing a watch movement between an inner bezel and a backing member, wherein assembling the forms together into a watch case includes assembling the middle and lower cases over the inner bezel, watch movement, and backing member. The method can include assembling a 24 carat gold upper case onto the middle case, which can include work hardening 24 carat gold into a form for the upper case and machining the form.

This disclosure also includes a watch comprising a 24 carat gold watch case. The watch case can include an middle case and a lower case joined together, wherein each of the middle and lower cases is formed by stamping 24 carat gold into a form having a Vickers hardness of about 65 to 75, and machining the form.

It is also contemplated that the watch can include an inner bezel within the watch case, wherein the inner bezel includes a material stronger than the 24 carat gold bezel. A movement can be mounted between the inner bezel and a backing member, wherein the inner bezel and backing member are configured to preserve function of the movement in the event of deformation of the case. A 24 carat gold upper case can be mounted to the middle case.

The watch can include a watchband. The band can include a mesh having a plurality of fastener holes defined therethrough. A flexible strip of material including a plurality of fastener holes therethrough is fastened to the metal mesh with respective fasteners passing through the fastener holes in the mesh and flexible strip. The fastener holes of at least one of the mesh and flexible strip are elongated in the direction along the flexible strip to reduce wrinkling in the flexible strip and mesh in the event of flexure of the flexible strip and mesh.

For example, the fastener holes in the mesh can be elongated in the direction along the flexible strip wherein the fastener holes in the flexible strip are not elongated in the direction along the flexible strip. The mesh can be a metal mesh, e.g., stainless steel 316L, or any other suitable material. The flexible strip can include leather, rubber, or any other suitable material. For example, the flexible strip can include genuine materials such as genuine crocodile or the like.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic view of an exemplary method in accordance with the subject disclosure, showing a process for forming a watch case;

FIG. 2 is an exploded perspective view of an exemplary embodiment of a watch case constructed in accordance with the present disclosure, showing the 24 carat gold case and inner bezel; and

FIG. 3 is a schematic perspective view of a portion of the watchband of FIG. 2, showing one of the elongated fastener holes for preventing wrinkling and adding flexibility in the watchband.

### DETAILED DESCRIPTION OF THE PREFERRED EMBODIMENTS

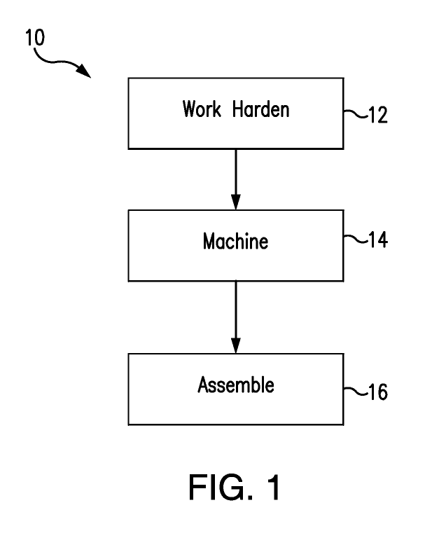

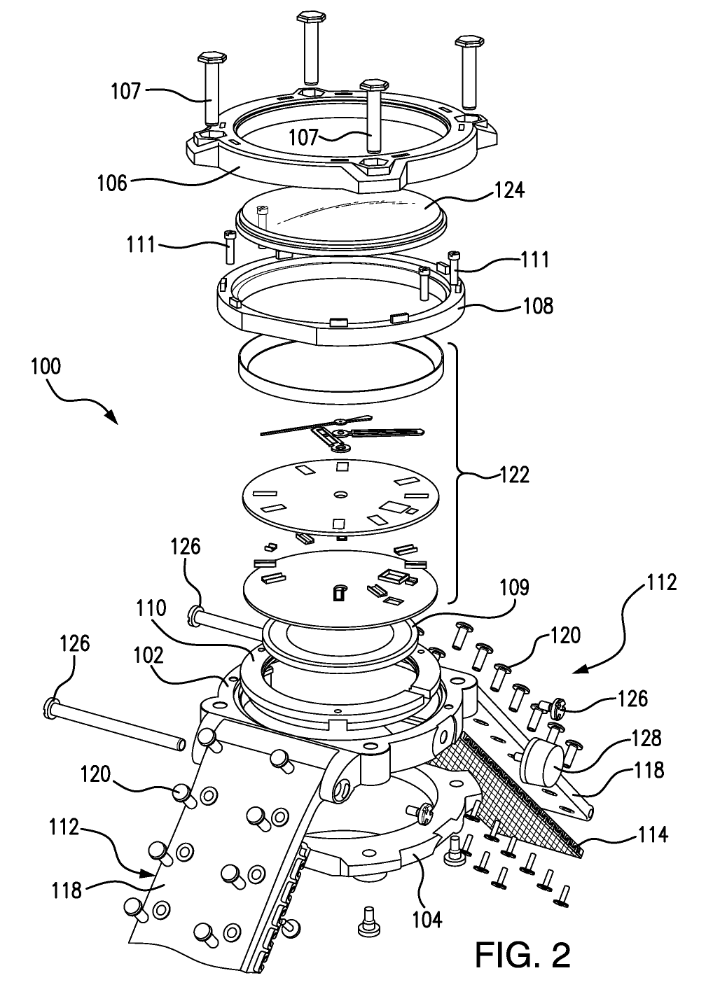

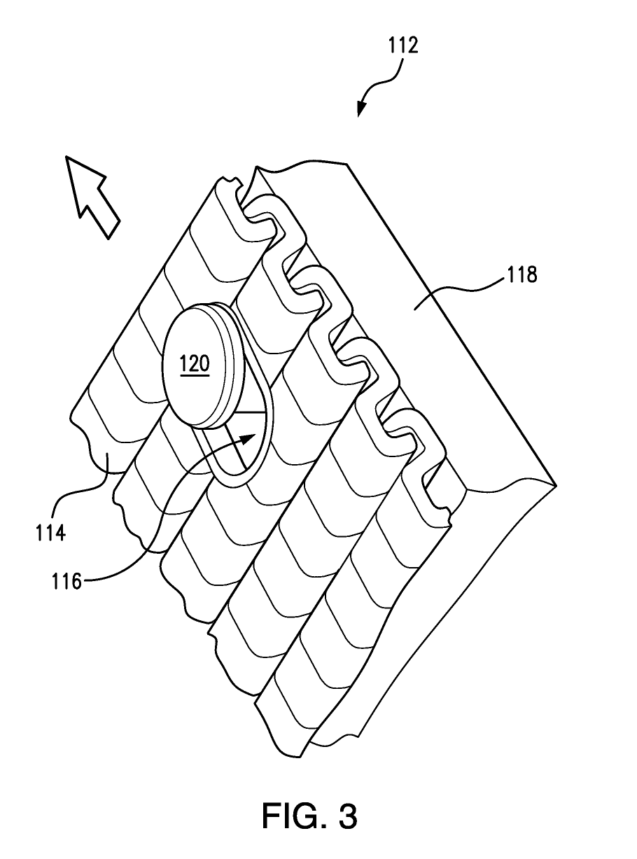

Reference will now be made to the drawings wherein like reference numerals identify similar structural features or aspects of the subject disclosure. For purposes of explanation and illustration, and not limitation, a partial view of an exemplary method in accordance with this disclosure is shown in FIG. 1 and is generally designated by reference character 10. An exemplary embodiment of a watch in accordance with the disclosure is shown in FIG. 2 and is designated generally by reference character 100. Other embodiments of watches in accordance with the disclosure, or aspects thereof, are provided in FIG. 3, as will be described. The systems and methods described herein can be used to provide gold watches improved over traditional gold watches.

Referring first to FIG. 1, a method 10 of forming a watch case (e.g., including middle case 102 and lower case 104 of FIG. 2) includes work hardening 24 carat gold to a Vickers harness of at or about 65 to 75, as indicated in box 12. Work hardening can include any suitable process for work hardening, but it is contemplated that stamping can advantageously provide the work hardening while also forming the 24 carat gold into a form or piece part that is partially formed and ready for finishing. As indicated by box 14 in FIG. 1, the method also includes machining the form or piece part into a watch case. Machining can include drilling, milling, and/or the like, and can finish the form provided from stamping, for example, to complete a part ready for assembly.

Work hardening 24 carat gold to about 65 to 75 Vickers renders the gold capable of being machined with suitable precision for watch parts, and also yields watch parts of sufficient hardness for structural purposes. In traditional gold watches, if the gold parts are to be machined, a harder gold alloy must be used, such as 18 carat gold, in order to attain sufficient material properties to allow machining. Moreover, in traditional techniques, 24 carat gold is not only too soft to machine, but in a finished product such as a watch, 24 carat gold is too soft to adequately protect a watch movement in the event of impact to the watch such as in everyday use. However, it has been discovered in conjunction with this disclosure that work hardening 24 carat gold to a hardness of about 65 to 75 on the Vickers scale (which is significantly more hardening than traditional techniques for 24 carat gold) renders the 24 carat gold capable of traditional machining.

Each of middle and lower cases 102 and 104 can be separately formed by stamping and machining, as described above, and the two cases 102 and 104 (together with upper case 106 described below) can then be assembled together to form a complete watch case, as indicated in box 16 of FIG. 1. The result is a 24 carat gold watch case, e.g., formed by the process described above.

With reference now to FIG. 2, an exemplary embodiment of a watch 100 includes a 24 carat gold watch case, e.g., a solid 24 carat gold watch case assembled from middle and lower cases 102 and 104 (and upper case 106) as described above, as opposed to a non-precious watch case plated or ornamented with 24 carat gold. A 24 carat upper case 106 is assembled on to middle and lower cases case 102 and 104 using fasteners 107. The watch 100 also includes an inner bezel 108 within the watch case. The inner bezel 108 includes a material, e.g., grade five titanium, which is stronger than the 24 carat gold upper case 106. A watch movement 109 is mounted within the inner bezel 108, between inner bezel 108 and a backing member 110, which can be made of steel, stainless steel, or the like. Inner bezel 108 and backing member 110 protect movement 109 and secure water resistance of the case, e.g., in the event of deformation of the 24 carat gold case. Inner bezel 108 is joined together with middle case 102 with fasteners 111. Inner bezel 108 can therefore be considered part of the housing for the movement 109, and backing member 110 is a movement holder since movement 109 is attached to backing member 110.

With continued reference to FIG. 2, upper case 106 and middle case 102 secure a window 124 and watch face components 122 therebetween. A crown 128 accesses movement 109 through the sidewall of middle case 102. Fasteners 126 secure watchband 112 to middle case 102.

Referring now to FIG. 3, an exemplary embodiment of a watchband 112 includes a metal mesh 114, e.g., made of stainless steel 316L links, or any other suitable material. The mesh 114 includes a plurality of fastener holes 116 therethrough, only one of which is shown in FIG. 3, but see also FIG. 2. A flexible strip 118 of material, such as leather, rubber, or the like, is fastened to the metal mesh 114 with respective fasteners 120 passing through the fastener holes 116 in the metal mesh 114. For example, the flexible strip 118 can include genuine materials such as genuine crocodile or the like. The fastener holes 116 are elongated in the direction, indicated in FIG. 3 with the large arrow, along the flexible strip 118 to reduce wrinkling in the flexible strip 118 in the event of flexure of the flexible strip 118 and metal mesh 114. It is also contemplated that the elongated fastener holes 116 can instead or additionally be defined in the flexible strip 118. This configuration can benefit not only watchbands, but bracelets, or any other suitable strip where two different materials are used together.

The methods and systems of the present disclosure, as described above and shown in the drawings, provide for watches with superior properties including high purity gold cases, a two-material band with substantially no wrinkling when flexing, and a protected movement. While the apparatus and methods of the subject disclosure have been shown and described with reference to preferred embodiments, those skilled in the art will readily appreciate that changes and/or modifications may be made thereto without departing from the spirit and scope of the subject disclosure.

What is claimed is:

1. A method of forming a watch case comprising:
work hardening 24 carat gold into a form having a Vickers hardness of about 65 to 75; and
machining the form into a watch case.

2. A method as recited in claim 1, wherein work hardening includes stamping 24 carat gold into a form.

3. A method as recited in claim 1, wherein work hardening and machining include work hardening 24 carat gold into forms for an middle case and a lower case, wherein machining includes machining at least one of the forms, and further comprising assembling the forms together into a watch case.

4. A method as recited in claim 1, further comprising housing a watch movement between an inner bezel and a backing member, wherein assembling the forms together into a watch case includes assembling the middle and lower cases over the inner bezel, watch movement, and backing member.

5. A method as recited in claim 1, further comprising assembling a 24 carat gold upper case onto the middle case.

6. A method as recited in claim 1, further comprising work hardening 24 carat gold into a form for an upper case; and machining the form for an upper case.

7. A watch comprising:
a 24 carat gold watch case.

8. A watch as recited in claim 7, wherein the watch case includes an middle case and a lower case joined together, wherein each of the middle and lower cases is formed by stamping 24 carat gold into a form having a Vickers hardness of about 65 to 75, and machining the form.

9. A watch as recited in claim 7, further comprising an inner bezel within the watch case, wherein the inner bezel includes a material stronger than the 24 carat gold bezel.

10. A watch as recited in claim 9, further comprising a movement mounted between the inner bezel and a backing member, wherein the inner bezel and backing member are configured to preserve function of the movement in the event of deformation of the case.

11. A watch as recited in claim 9, further comprising a 24 carat gold upper case mounted to the middle case.

12. A watch as recited in claim 7, further comprising a watch band that includes:
a metal mesh with a plurality of fastener holes defined therethrough; and
a flexible strip of material fastened to the metal mesh with respective fasteners passing through the fastener holes in the metal mesh, wherein the fastener holes are elongated in the direction along the flexible strip to reduce wrinkling in the flexible strip in the event of flexure of the flexible strip and metal mesh.

13. A band comprising:
a mesh including a plurality of fastener holes therethrough; and
a flexible strip of material including a plurality of fastener holes therethrough, wherein the flexible strip is fastened to the metal mesh with respective fasteners passing through the fastener holes in the mesh and flexible strip, wherein the fastener holes of at least one of the mesh and flexible strip are elongated in the direction along the flexible strip to reduce wrinkling in the flexible strip and mesh in the event of flexure of the flexible strip and mesh.

14. A band as recited in claim 13, wherein the fastener holes in the mesh are elongated in the direction along the flexible strip and the fastener holes in the flexible strip are not elongated in the direction along the flexible strip.

15. A band as recited in claim 13, wherein the mesh is a metal mesh.

16. A band as recited in claim 15, wherein the mesh is stainless steel 316L.

17. A band as recited in claim 13, wherein the flexible strip includes leather.

18. A band as recited in claim 13, wherein the flexible strip includes rubber.

19. A band as recited in claim 13, wherein the flexible strip includes genuine crocodile.
